(19) United States
(12) Patent Application Publication
(10) Pub. No.: US 2022/0365799 A1
(43) Pub. Date: Nov. 17, 2022

(54) USING MACHINE LEARNING MODELS TO SIMULATE PERFORMANCE OF VACUUM TUBE AUDIO HARDWARE

(71) Applicant: Iyo Inc., Redwood City, CA (US)

(72) Inventors: Jason Rugolo, Mountain View, CA (US); Simon Carlile, San Francisco, CA (US)

(21) Appl. No.: 17/322,747

(22) Filed: May 17, 2021

(51) Int. Cl. G06F 9/455; G06N 3/08; G06N 3/04

(52) U.S. Cl. CPC G06F 9/45504; G06N 3/08; G06N 3/0445

(57) ABSTRACT

In some embodiments, a hardware simulation computing system is provided. The hardware simulation computing system is configured to provide audio signals from a low-performance audio device as input to a machine learning model capable of exhibiting temporal dynamic behavior; to update the machine learning model based on a comparison of outputs of the machine learning model to ground truth audio signals from a high-performance audio device; and to repeat the providing and updating actions until a completion threshold is reached to create a trained machine learning model.

### TECHNICAL FIELD

This disclosure relates generally to audio recording and/or reproduction equipment, and in particular but not exclusively, relates to simulating output from one type of audio equipment using another type of audio equipment.

### BACKGROUND

It has long been considered that in order to obtain the best quality sound from audio equipment, equipment that uses vacuum tubes should be used. Due to complex ways in which the physical characteristics of vacuum tubes affect their electrical performance characteristics, vacuum tubes provide a “warmth” to recorded and reproduced sound that is not provided by audio equipment that only uses transistors or otherwise does not use vacuum tubes.

Unfortunately, audio equipment that uses vacuum tubes are specialized equipment that can be prohibitively expensive, while audio equipment that uses transistors is becoming ever more inexpensive and ubiquitous. What is desired are techniques that can reproduce the performance of high-quality, vacuum tube-based audio equipment using lower-quality, transistor-based audio equipment.

### BRIEF SUMMARY

In some embodiments, a non-transitory computer-readable medium having logic stored thereon is provided. The logic, in response to execution by one or more processors of a hardware simulation computing system, causes the hardware simulation computing system to perform actions for training a machine learning model to simulate performance of a high-performance audio device. The actions include providing, by the hardware simulation computing system, audio signals from a low-performance audio device as input to the machine learning model, where the machine learning model is capable of exhibiting temporal dynamic behavior; updating, by the hardware simulation computing system, the machine learning model based on a comparison of outputs of the machine learning model to ground truth audio signals from a high-performance audio device; repeating, by the hardware simulation computing system, the providing and updating actions until a completion threshold is reached to create a trained machine learning model; and storing, by the hardware simulation computing system, the trained machine learning model in a model data store.

In some embodiments, a non-transitory computer-readable medium having logic stored thereon is provided. The logic, in response to execution by one or more processors of a computing device, causes the computing device to perform actions including receiving, by the computing device, an audio signal from a low-performance audio device; providing, by the computing device, the audio signal as input to a trained machine learning model to generate an output that simulates an audio signal from a high-performance audio device, where the trained machine learning model is capable of exhibiting temporal dynamic behavior; and providing, by the computing device, the simulated audio signal for presentation by a loudspeaker.

In some embodiments, a system for training a machine learning model is provided. The system includes at least one audio source, a low-performance audio device configured to receive audio signals from the audio source, and a high-performance audio device configured to receive audio signals from the audio source contemporaneously with the low-performance audio device. The system also includes a hardware simulation computing system communicatively coupled to the low-performance audio device and the high-performance audio device. The hardware simulation computing system includes logic that, in response to execution by one or more processors of the hardware simulation computing system, causes the hardware simulation computing system to perform actions for training a machine learning model to simulate performance of the high-performance audio device. The actions include providing, by the hardware simulation computing system, audio signals from the low-performance audio device as input to the machine learning model, where the machine learning model is capable of exhibiting temporal dynamic behavior; updating, by the hardware simulation computing system, the machine learning model based on a comparison of outputs of the machine learning model to ground truth audio signals from a high-performance audio device; repeating, by the hardware simulation computing system, the providing and updating actions until a completion threshold is reached to create a trained machine learning model; and storing, by the hardware simulation computing system, the trained machine learning model in a model data store.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1A is a simplified schematic drawing illustrating some components of a non-limiting example embodiment of a high-performance audio device according to various aspects of the present disclosure.

FIG. 1B is a simplified schematic drawing illustrating some components of a non-limiting example embodiment of a low-performance audio device according to various aspects of the present disclosure.

FIG. 2 is a schematic illustration of a system for training a machine learning model to simulate output signals generated by a high-performance audio device using signals from a low-performance audio device according to various aspects of the present disclosure.

FIG. 3 is a block diagram that illustrates aspects of a non-limiting example embodiment of a hardware simulation computing system according to various aspects of the present disclosure.

FIG. 4 is a block diagram that illustrates, at a high level, a machine learning model and the process of training it according to various aspects of the present disclosure.

FIG. 5 is a flowchart that illustrates a non-limiting example embodiment of a method of training a machine learning model to simulate a response of a high-performance audio device according to various aspects of the present disclosure.

FIG. 6 is a flowchart that illustrates a non-limiting example embodiment of a method of using a machine learning model to simulate a response of a high-performance audio device according to various aspects of the present disclosure.

### DETAILED DESCRIPTION

In some embodiments of the present disclosure, machine learning models are trained to take as input a signal from a low-performance audio device (such as an audio device that uses transistors instead of vacuum tubes), and to provide as output a signal simulating that which would be produced by a high-performance audio device (such as an audio device that uses vacuum tubes). Particular types of machine learning models are chosen as described in detail below in order to capture the temporal and spectral variation in the output of the high-performance audio device that is introduced by the physical characteristics of the vacuum tubes and that provides the “warmth” often described in the output of such devices.

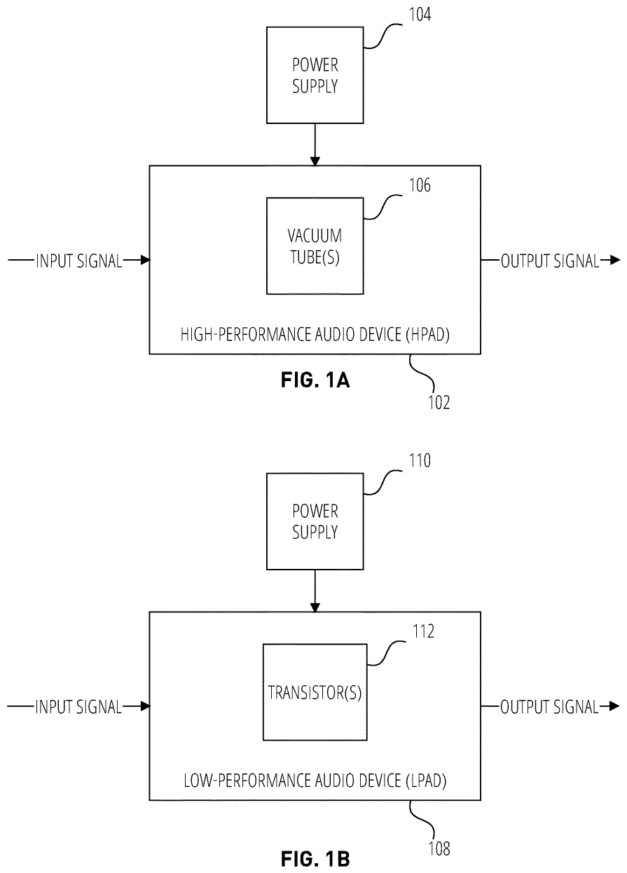

FIG. 1A is a simplified schematic drawing illustrating some components of a non-limiting example embodiment of a high-performance audio device according to various aspects of the present disclosure. The high-performance audio device 102 (also referred to herein as an “HPAD” for conciseness) accepts an input signal and passes the input signal through circuitry that includes one or more vacuum tubes 106 to produce an output signal. Often, the high-performance audio device 102 is also coupled to a power supply 104 that provides a voltage for operating the circuitry including the vacuum tubes 106.

In some embodiments, the high-performance audio device 102 may be a microphone. For such high-performance audio devices 102, the input signal may be sound waves generated by an audio source, and the output signal may be an analog or digital electrical signal output by the microphone. One of ordinary skill in the art will recognize that high-performance audio devices 102 such as microphones have other circuitry other than vacuum tubes 106, including but not limited to condenser(s) and transformer(s). This circuitry is omitted from the diagram and the description for the sake of brevity. In some embodiments, the high-performance audio device 102 may be a portion or component of a microphone. For such high-performance audio devices 102, the input signal may be an electrical signal from a condenser or other component of the microphone, and the output signal may be an analog or digital electrical signal output by the microphone (or output to other components of the microphone).

In some embodiments, the high-performance audio device 102 may be an audio device other than a microphone that uses one or more vacuum tubes 106. For example, in some embodiments, the high-performance audio device 102 may be a preamp, an amplifier, or a component thereof. In such embodiments, the input signal is an analog or digital electrical signal received from another audio device, and the output signal is an analog or digital electrical signal to be provided for presentation by a loudspeaker (either directly or after passing through one or more other audio devices).

FIG. 1B is a simplified schematic drawing illustrating some components of a non-limiting example embodiment of a low-performance audio device according to various aspects of the present disclosure. The low-performance audio device 108 (also referred to herein as an “LPAD” for conciseness) also accepts an input signal and passes the input signal through circuitry to produce an output signal. Unlike the high-performance audio device 102, the low-performance audio device 108 does not include any vacuum tubes, and instead includes one or more transistors 112 to provide similar capabilities. Otherwise, the low-performance audio device 108 is very similar to the high-performance audio device 102, and may be a microphone, a preamp, an amplifier, a component thereof, or any other type of audio device.

Though described as a “low-performance” device, the low-performance audio device 108 may provide objectively good measurable performance (e.g., good frequency response, good effective frequency range, good sensitivity, good noise level, good distortion, etc.) compared to a high-performance audio device 102. However, due to the inherent time-dependent physical characteristics of the vacuum tubes 106 versus the transistors 112 and the coloring of the output signal that they cause, the output signals of the high-performance audio devices 102 are considered higher-quality signals than those produced by the low-performance audio devices 108.

Also, though described as a single device, in some embodiments the low-performance audio device 108 may include an array of devices. For example, the low-performance audio device 108 may include an array of microphones including but not limited to MEMS microphones. The array of microphones may provide separate output signals, or may provide a single output signal that represents a combination of signals received from the array of microphones.

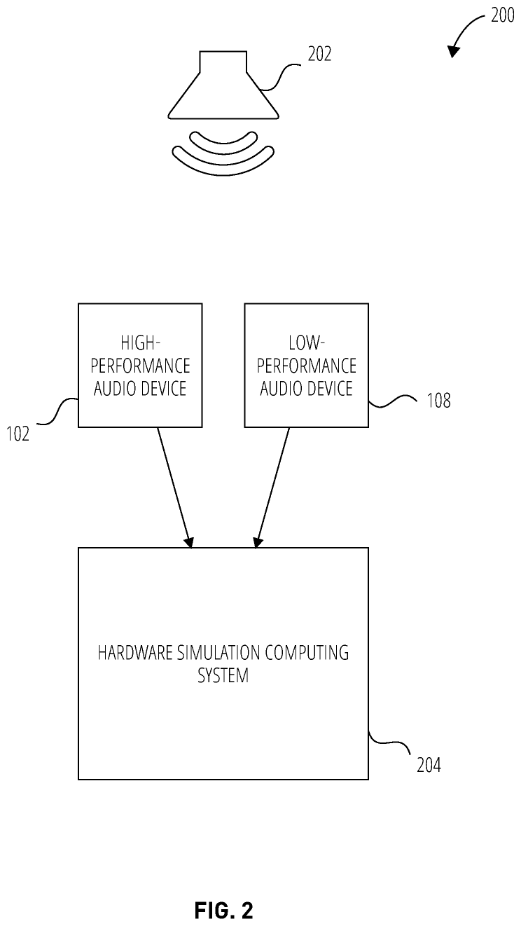

FIG. 2 is a schematic illustration of a system for training a machine learning model to simulate output signals generated by a high-performance audio device using signals from a low-performance audio device according to various aspects of the present disclosure.

In the system 200, an audio source 202 is provided. In some embodiments, the audio source 202 may be any type of audio source that generates sound, including but not limited to a loudspeaker for playing recorded audio, a human speaker or singer, one or more musical instruments, or any other source of sound. Such audio sources are appropriate when the high-performance audio device 102 and low-performance audio device 108 are microphones or components of microphones. In some embodiments, the audio source 202 may be any type of audio source that generates an output signal that represents sound, including but not limited to an electrified instrument (such as an electric guitar or bass), a synthesizer, a turntable, a AM/FM receiver, or a digital recording player. Such audio sources are appropriate when the high-performance audio device 102 and low-performance audio device 108 are preamps, amplifiers, or components thereof.

In some embodiments, the audio source 202 may be a given type of audio source that matches that of an audio source from which audio will later be processed by the trained machine learning model. This allows the training data generated by the system 200 to include similar characteristics to the live data to be processed by the trained machine learning model, and may lead to higher performance for the trained machine learning model if it is intended to only be used for audio from the given type of audio source. In some embodiments, multiple different audio sources 202 may be used in the system 200 during training of the machine learning models in order to avoid overfitting to a particular type of audio source 202. This allows the trained machine learning model to generate appropriate results for multiple different types of audio sources 202.

In the system 200, a high-performance audio device 102 and a low-performance audio device 108 are provided such that they receive sound from the audio source 202 and provide corresponding output signals to the hardware simulation computing system 204. The high-performance audio device 102 and the low-performance audio device 108 are arranged such that the sound received by each device from the audio source 202 is as similar as possible. This may include arranging the high-performance audio device 102 and the low-performance audio device 108 in close physical proximity to each other, arranging the high-performance audio device 102 and the low-performance audio device 108 at matching distances from the audio source 202, or in any other suitable arrangement. By doing so, the high-performance audio device 102 and low-performance audio device 108 can contemporaneously receive sound from the audio source 202 in order to generate pairs of training data as described in further detail below.

In some embodiments, the system 200 may be arranged such that the high-performance audio device 102, the low-performance audio device 108, and the audio source 202 are positioned within an anechoic environment so that outside influences on the sound reaching the high-performance audio device 102 and the low-performance audio device 108 from the audio source 202 are minimized. In some embodiments, the system 200 may be arranged such that the high-performance audio device 102, the low-performance audio device 108, and the audio source 202 are positioned in an environment that closely matches an intended use environment for the low-performance audio device 108 when paired with a trained machine learning model to allow the training data to include any background noise, echo, or other environmental conditions expected to be encountered during actual use to improve the eventual performance of the trained machine learning model in the intended use environment.

The hardware simulation computing system 204 can then use the pairs of training data to train machine learning models to simulate the performance of the high-performance audio device 102 as described in further detail below.

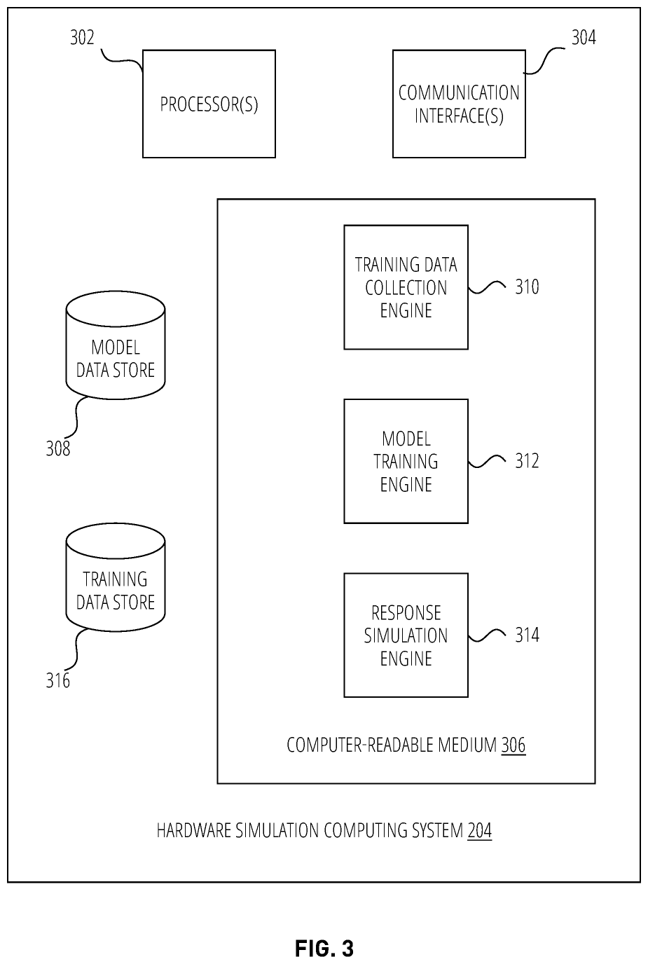

FIG. 3 is a block diagram that illustrates aspects of a non-limiting example embodiment of a hardware simulation computing system according to various aspects of the present disclosure. The illustrated hardware simulation computing system 204 may be implemented by any computing device or collection of computing devices, including but not limited to a desktop computing device, a laptop computing device, a mobile computing device, a server computing device, a computing device of a cloud hardware simulation computing system, and/or combinations thereof.

The hardware simulation computing system 204 is configured to receive output signals from high-performance audio devices 102 and low-performance audio devices 108, and to use the signals to train machine learning models to simulate the performance of the high-performance audio devices 102. The hardware simulation computing system 204 is also configured to use the trained machine learning models and/or to provide the trained machine learning models to other computing devices for use in simulating the performance of the high-performance audio devices 102.

As shown, the hardware simulation computing system 204 includes one or more processors 302, one or more communication interfaces 304, a model data store 308, a training data store 316, and a computer-readable medium 306.

In some embodiments, the processors 302 may include any suitable type of general-purpose computer processor. In some embodiments, the processors 302 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 304 include one or more hardware and or software interfaces suitable for providing communication links between components. The communication interfaces 304 may support one or more wired networking communication technologies (including but not limited to Ethernet, FireWire, HDMI, and USB), one or more wireless networking communication technologies (including but not limited to Wi-Fi, WiMAX, Bluetooth, 2G, 3G, 4G, 5G, and LTE), and/or combinations thereof. The communication interfaces 304 may also support one or more digital or analog audio communication technologies, including but not limited to transmitting signals via cables with 3.5 mm connectors, ¼ inch connectors, XLR connectors, RCA connectors, MIDI connectors, TOSLINK or other optical connectors, or any other type of digital or analog audio communication technology.

As shown, the computer-readable medium 306 has stored thereon logic that, in response to execution by the one or more processors 302, cause the hardware simulation computing system 204 to provide a training data collection engine 310, a model training engine 312, and a response simulation engine 314.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the training data collection engine 310 is configured to receive output signals from high-performance audio devices 102 and low-performance audio devices 108, and to store training data pairs based thereon in the training data store 316. In some embodiments, the model training engine 312 is configured to use the training data pairs stored in the training data store 316 to train machine learning models, which it then stores in the model data store 308. In some embodiments, the response simulation engine 314 is configured to retrieve trained machine learning models from the model data store 308 and to use them to simulate output signals that would be generated by high-performance audio device 102 based on output signals from low-performance audio devices 108.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

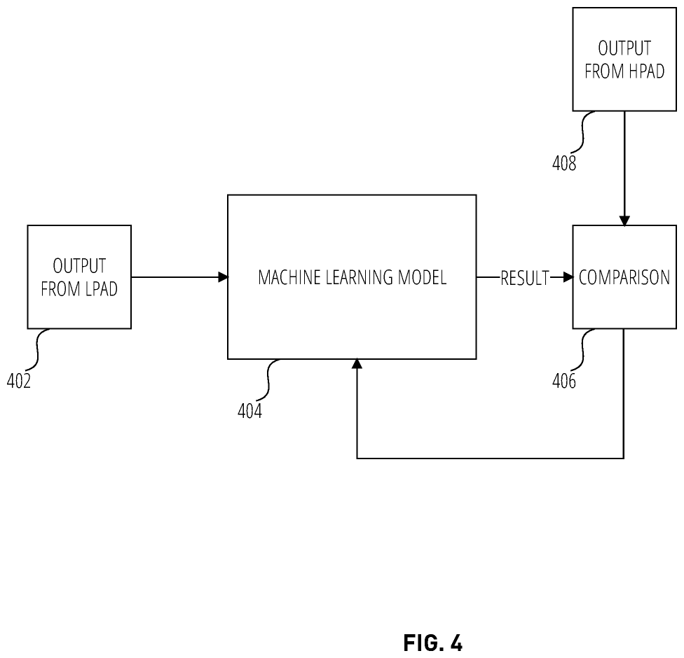

FIG. 4 is a block diagram that illustrates, at a high level, a machine learning model and the process of training it according to various aspects of the present disclosure.

As shown, a training pair is used that includes output from LPAD 402 and output from HPAD 408. The output from LPAD 402 and the output from HPAD 408 were received based on a common audio source 202 that was contemporaneously received by the high-performance audio device 102 and the low-performance audio device 108, as illustrated in FIG. 2.

The output from LPAD 402 is provided as input to the machine learning model 404. The machine learning model 404 processes its input to generate a result. A comparison 406 of the result of the machine learning model 404 and the output from HPAD 408 is performed, and differences between the result and the output from HPAD 408 are used to update the machine learning model 404. By repeating this process a large number of times for a large number of training pairs, the performance of the machine learning model 404 will improve over time and eventually the output of the machine learning model 404 will approach the performance of the high-performance audio device 102.

As noted above, the physical characteristics of vacuum tubes 106 cause the vacuum tubes 106 to have particular response characteristics over time. That is, for particular changes over time in input amplitude or frequency, the vacuum tubes 106 provide different output signals than solid-state components would, thus creating the “warm” sound associated with high-performance audio devices 102. To help model this behavior that changes over time, the machine learning model 404 is of a type that exhibits temporal dynamic behavior. One non-limiting example embodiment of a suitable machine learning model 404 is a recurrent neural network.

One non-limiting example embodiment of a specific type of recurrent neural network model that provides reasonable results when chosen to be used within embodiments of the present disclosure as a machine learning model 404 is a WaveRNN model, a single-layer RNN with a dual softmax layer that is designed to efficiently predict raw audio samples. While WaveRNN models were originally created in the field of text-to-speech synthesis, it has been found by the inventors of the present disclosure that trained models based on WaveRNN also provide high-quality results when chosen for use as a machine learning model 404 for simulating outputs from high-performance audio devices 102.

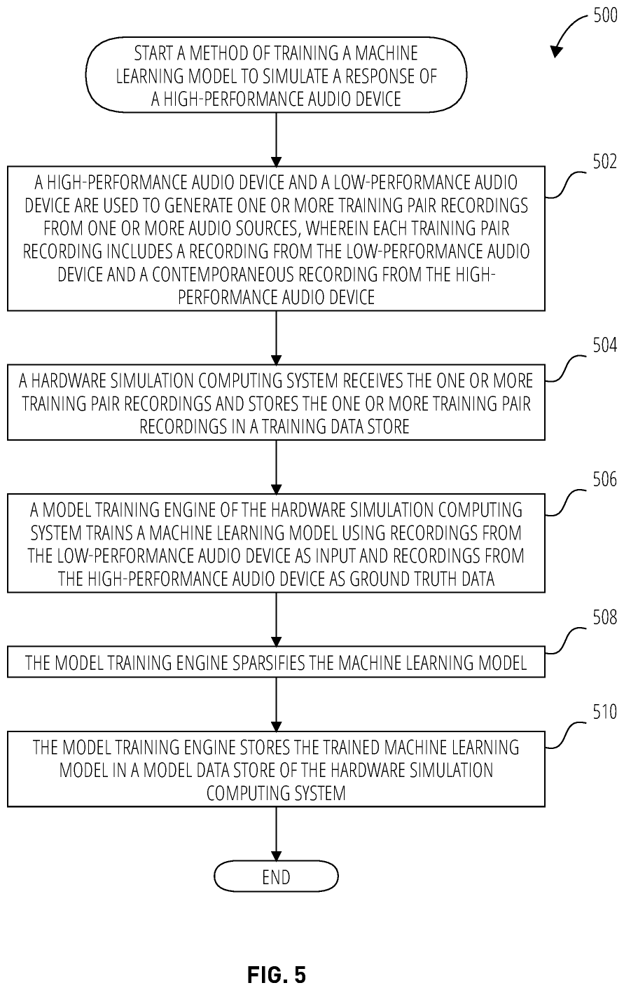

FIG. 5 is a flowchart that illustrates a non-limiting example embodiment of a method of training a machine learning model to simulate a response of a high-performance audio device according to various aspects of the present disclosure.

From a start block, the method 500 proceeds to block 502, where a high-performance audio device 102 and a low-performance audio device 108 are used to generate one or more training pair recordings from one or more audio sources 202, wherein each training pair recording includes a recording from the low-performance audio device 108 and a contemporaneous recording from the high-performance audio device 102. As described above, a system such as system 200 may be used in block 502 to generate training pair recordings, wherein the low-performance audio device 108 and the high-performance audio device 102 are situated such that they contemporaneously receive matching sound.

In some embodiments, a single audio source 202 may be used in block 502, and each training pair recording may represent different time periods during which the single audio source 202 produced sound. In some embodiments, different audio sources 202 may be used in block 502 to generate different training pair recordings.

At block 504, a hardware simulation computing system 204 receives the one or more training pair recordings and stores the one or more training pair recordings in a training data store 316. In some embodiments, the hardware simulation computing system 204 may receive the recordings of the one or more training pair recordings directly from the high-performance audio device 102 and the low-performance audio device 108 while they are being recorded. In some embodiments, the hardware simulation computing system 204 may receive the output signals from the high-performance audio device 102 and the low-performance audio device 108 while they are being generated, and the hardware simulation computing system 204 may itself create the recordings of the output signals. In some embodiments, the training pair recordings are stored along with timestamp, synchronization, or other data that allows the hardware simulation computing system 204 to accurately and precisely align the recordings with each other.

At block 506, a model training engine 312 of the hardware simulation computing system 204 trains a machine learning model 404 using recordings from the low-performance audio device 108 as input and recordings from the high-performance audio device 102 as ground truth data. In some embodiments, a procedure similar to that illustrated in FIG. 4 may be used to train the machine learning model 404. Typically, this is an iterative process in which each relevant training pair recording stored in the training data store 316 may be passed through the procedure illustrated in FIG. 4 one or more times. The iterative process may repeat the processing of the input, comparing the output to the ground truth data, and updating the machine learning model 404 for a predetermined number of iterations, until performance of the machine learning model 404 converges to a desired goal, or until any other suitable endpoint.

At block 508, the model training engine 312 sparsifies the machine learning model 404. By sparsifying the machine learning model 404, the model training engine 312 can reduce the computational processing needed to process live data using the trained and sparsified machine learning model 404 while retaining the performance obtained during training. In some embodiments, the sparsification illustrated as part of block 508 occurs during the iterative training described at block 506. For example, in some embodiments, every given number of iterations the weights in the machine learning model 404 may be sorted, and the k least significant weights may be zeroed out (where k may be a fraction of the total number of weights that is increased until a target sparsity is reached, or may be any other suitable value) in order to essentially remove the associated nodes from later computations.

At block 510, the model training engine 312 stores the trained machine learning model 404 in a model data store 308 of the hardware simulation computing system 204. The method 500 then proceeds to an end block and terminates.

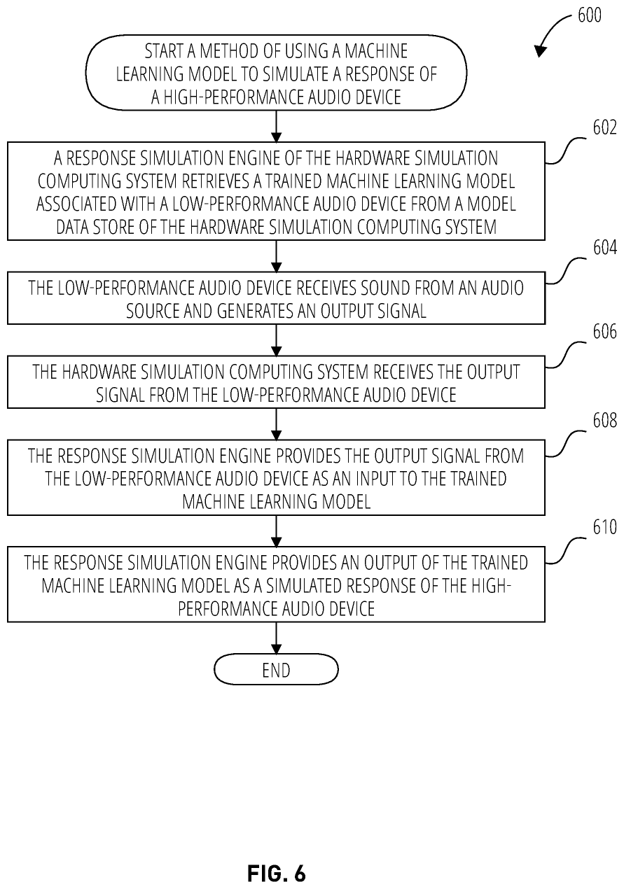

FIG. 6 is a flowchart that illustrates a non-limiting example embodiment of a method of using a machine learning model to simulate a response of a high-performance audio device according to various aspects of the present disclosure.

From a start block, the method 600 proceeds to block 602, where a response simulation engine 314 of the hardware simulation computing system 204 retrieves a trained machine learning model 404 associated with a low-performance audio device 108 from a model data store 308 of the hardware simulation computing system 204. In some embodiments, the model data store 308 may store machine learning models 404 associated with multiple low-performance audio devices 108, and the particular low-performance audio device 108 for which the trained machine learning model 404 should be retrieved may be specified by a configuration setting, by the hardware simulation computing system 204 automatically detecting a model, type, or serial number of the low-performance audio device 108, or via any other suitable technique.

At block 604, the low-performance audio device 108 receives sound from an audio source 202 and generates an output signal. At block 606, the hardware simulation computing system 204 receives the output signal from the low-performance audio device 108. As noted above, this may be performed using any suitable technology for transmitting audio signals.

At block 608, the response simulation engine 314 provides the output signal from the low-performance audio device 108 as an input to the trained machine learning model 404, and at block 610, the response simulation engine 314 provides an output of the trained machine learning model 404 as a simulated response of the high-performance audio device 102. In some embodiments, the output of the trained machine learning model 404 may be converted by the hardware simulation computing system 204 directly into an electrical or optical signal that can be provided to an amplifier or loudspeaker for presentation. In some embodiments, the output of the trained machine learning model 404 may be stored by the hardware simulation computing system 204 as an enhanced recording.

The method 600 then proceeds to an end block and terminates.

The method 600 is described above as being performed on live signals received from the low-performance audio device 108. That said, such example embodiments should not be seen as limiting. In other embodiments, the signals from the low-performance audio device 108 may be recorded and processed by the response simulation engine 314 offline.

In some embodiments, components of the hardware simulation computing system 204 related to training and storing the machine learning model 404, such as the model data store 308, the training data store 316, the training data collection engine 310, and the model training engine 312, may be provided by a first computing system, while components of the hardware simulation computing system 204 related to executing trained machine learning models 404, such as the response simulation engine 314, may be provided by a second computing system that retrieves appropriate machine learning models 404 from the first computing system.

One advantage of embodiments of the present disclosure is that by choosing an appropriate type of machine learning model 404, such as a sparsified WaveRNN, latencies introduced by the processing may be as low as milliseconds, even on edge computing hardware such as laptop computing devices, tablet computing devices, and/or smartphone computing devices, thus allowing such edge computing devices to act as the second computing system described above.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having logic stored thereon that, in response to execution by one or more processors of a hardware simulation computing system, causes the hardware simulation computing system to perform actions for training a machine learning model to simulate performance of a high-performance audio device, the actions comprising:
providing, by the hardware simulation computing system, audio signals from a low-performance audio device as input to the machine learning model, wherein the machine learning model is capable of exhibiting temporal dynamic behavior;
updating, by the hardware simulation computing system, the machine learning model based on a comparison of outputs of the machine learning model to ground truth audio signals from a high-performance audio device;
repeating, by the hardware simulation computing system, the providing and updating actions until a completion threshold is reached to create a trained machine learning model; and
storing, by the hardware simulation computing system, the trained machine learning model in a model data store.

2. The non-transitory computer-readable medium of claim 1, wherein the machine learning model capable of exhibiting temporal dynamic behavior is a recurrent neural network.

3. The non-transitory computer-readable medium of claim 2, wherein the recurrent neural network is a WaveRNN model.

4. The non-transitory computer-readable medium of claim 1, wherein the actions further comprise sparsifying the machine learning model while repeating the providing and updating actions.

5. The non-transitory computer-readable medium of claim 1, wherein the actions further comprise transmitting the trained machine learning model to an edge device for execution.

6. The non-transitory computer-readable medium of claim 1, wherein the actions further comprise:
contemporaneously receiving an audio signal from the low-performance audio device and an audio signal from the high-performance audio device based on a common audio source; and
storing the audio signals as a training pair in a training data store.

7. The non-transitory computer-readable medium of claim 6, wherein the audio signal from the low-performance audio device provided as input to the machine learning model and the ground truth audio signal from the high-performance audio device are from a training pair retrieved from the training data store.

8. The non-transitory computer-readable medium of claim 1, wherein the high-performance audio device includes one or more vacuum tubes, and wherein the low-performance audio device does not include a vacuum tube.

9. A non-transitory computer-readable medium having logic stored thereon that, in response to execution by one or more processors of a computing device, causes the computing device to perform actions comprising:
receiving, by the computing device, an audio signal from a low-performance audio device;
providing, by the computing device, the audio signal as input to a trained machine learning model to generate an output that simulates an audio signal from a high-performance audio device, wherein the trained machine learning model is capable of exhibiting temporal dynamic behavior; and
providing, by the computing device, the simulated audio signal for presentation by a loudspeaker.

10. The non-transitory computer-readable medium of claim 9, wherein the trained machine learning model capable of exhibiting temporal dynamic behavior is a recurrent neural network.

11. The non-transitory computer-readable medium of claim 10, wherein the recurrent neural network is a WaveRNN model.

12. The non-transitory computer-readable medium of claim 9, wherein the trained machine learning model is sparsified during training.

13. The non-transitory computer-readable medium of claim 9, wherein the computing device is an edge device.

14. The non-transitory computer-readable medium of claim 9, wherein the high-performance audio device includes one or more vacuum tubes, and wherein the low-performance audio device does not include one or more vacuum tubes.

15. A system for training a machine learning model, the system comprising:
at least one audio source;
a low-performance audio device configured to receive audio signals from the audio source and;
a high-performance audio device configured to receive audio signals from the audio source contemporaneously with the low-performance audio device; and
a hardware simulation computing system communicatively coupled to the low-performance audio device and the high-performance audio device, wherein the hardware simulation computing system includes logic that, in response to execution by one or more processors of the hardware simulation computing system, causes the hardware simulation computing system to perform actions for training a machine learning model to simulate performance of the high-performance audio device, the actions comprising:
providing, by the hardware simulation computing system, audio signals from the low-performance audio device as input to the machine learning model, wherein the machine learning model is capable of exhibiting temporal dynamic behavior;
updating, by the hardware simulation computing system, the machine learning model based on a comparison of outputs of the machine learning model to ground truth audio signals from a high-performance audio device;
repeating, by the hardware simulation computing system, the providing and updating actions until a completion threshold is reached to create a trained machine learning model; and
storing, by the hardware simulation computing system, the trained machine learning model in a model data store.

16. The system of claim 15, wherein the machine learning model capable of exhibiting temporal dynamic behavior is a recurrent neural network.

17. The system of claim 16, wherein the recurrent neural network is a WaveRNN model.

18. The system of claim 16, wherein the actions further comprise sparsifying the machine learning model while repeating the providing and updating actions.

19. The system of claim 15, wherein the actions further comprise transmitting the trained machine learning model to an edge device for execution.

20. The system of claim 15, wherein the high-performance audio device includes one or more vacuum tubes, and wherein the low-performance audio device does not include any vacuum tubes.
